(19) United States
(12) Patent Application Publication
(10) Pub. No.: US 2007/0089226 A1
(43) Pub. Date: Apr. 26, 2007

(54) Portable water therapy apparatus for large intestine

(76) Inventor: Hsin-Ming Chen, Taipei (TW)

Correspondence Address: COOPER & DUNHAM, LLP, 1185 AVENUE OF THE AMERICAS, NEW YORK, NY, 10036, US

(21) Appl. No.: 11/257,845

(22) Filed: Oct. 25, 2005

(51) Int. Cl. A61H 35/00

(52) U.S. Cl. 4/447; 604/276; 4/420.1; 4/420.4; 4/432; 4/445; 4/446

(57) ABSTRACT

A portable water therapy apparatus for the large intestine has a positioning pad, a controller, an inlet tube, an outlet tube, and a nozzle and a switch system. The controller comprises a filtering device, a heating device, a pressure control pump, and a switch system. The inlet tube has two ends, a first end is connected to the pressure control pump of the controller, and a second end is connected to a faucet, which eliminates the need to add water manually.

### BACKGROUND OF THE INVENTION

1. Field of the Invention

The present invention relates to a water therapy apparatus for the large intestine, and more particularly relates to a portable water therapy apparatus for the large intestine.

2. Description of the Related Art

Water therapy is often applied for constipation treatment. Warm water is flowed into the large intestine, with the help of a water therapy apparatus, to promote the peristalsis of the large intestine and facilitate evacuation of stool.

Water therapy treatment with water therapy apparatus is usually carried out in a hospital; however, water therapy apparatus for the large intestine can also be effective for users in the home. With reference to FIG. 5, a conventional water therapy apparatus for the large intestine, which can be used in the home, has a controller (60), a positioning pad (70), and a tube (80). The conventional apparatus is adapted to a toilet having a tank and a seat. The controller (60) is provided on the tank of the toilet, the positioning pad (70) is fixed at a rear end of the seat, and a guide tube (71) is mounted in the positioning pad (70) with a pipe (72) extending from a middle part of the guide tube (71). A nozzle (90) is connected to the pipe (72) and has multiple apertures (91) at a top end of the nozzle (90). The tube (80) has two ends, a first end is connected to the controller (60), and a second end is connected to the guide tube (71).

The controller (60) has a water storage tank, a pump, a pressure indicator, a temperature indicator, and a water volume indicator. The water in the tank is added manually, pumped through the tube (80), guide tube (71) and pipe (72), then into the nozzle (90) to spurt from the apertures (91).

With reference to FIG. 6, a user can sit on the seat and insert the nozzle (90) into the rectum. A control device on a cable is supplied for the user to control the water flow.

However, water has to be added manually when the level is low. The need for a large water storage tank makes the apparatus too big to carry, which is inconvenient for users who need to take the apparatus out of the home. In addition, the controller is placed on the water tank behind the user, which is makes it difficult for the user to monitor the pressure indicator, temperature indicator, etc.

Therefore, the invention provides a portable water therapy apparatus for the large intestine to mitigate or obviate the aforementioned problems.

### SUMMARY OF THE INVENTION

The main objective of the present invention is to provide a portable water therapy apparatus for the large intestine.

The portable water therapy apparatus for the large intestine has a positioning pad, a controller, an inlet tube, an outlet tube, a nozzle and a switch system.

The inlet tube is connected to a faucet, thus eliminating the need to add water manually as well as the need for a water storage tank.

When a user sits on the toilet, the controller is placed between the legs of the user and allows for convenient monitoring of the pressure indicator and the temperature indicator.

In addition, the positioning pad can be folded and the controller is comparatively small and easy to carry, which is convenient for the user to take out of the home if necessary.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a portable water therapy apparatus for the large intestine in accordance with this invention;

FIG. 2 is a block flow diagram of devices in a controller of the portable water therapy apparatus for the large intestine in FIG. 1;

FIG. 3 is a perspective view of the portable water therapy apparatus for the large intestine in FIG. 1;

FIG. 4 is an operational perspective view of the portable water therapy apparatus for the large intestine in FIG. 1;

FIG. 5 is a perspective view of a conventional water therapy apparatus for the large intestine; and

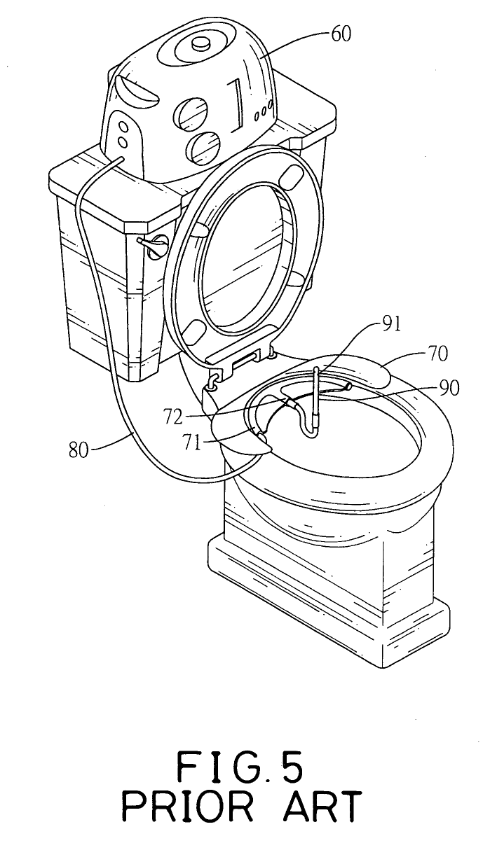

FIG. 6 is an operational perspective view of the conventional water therapy apparatus for the large intestine in FIG. 5.

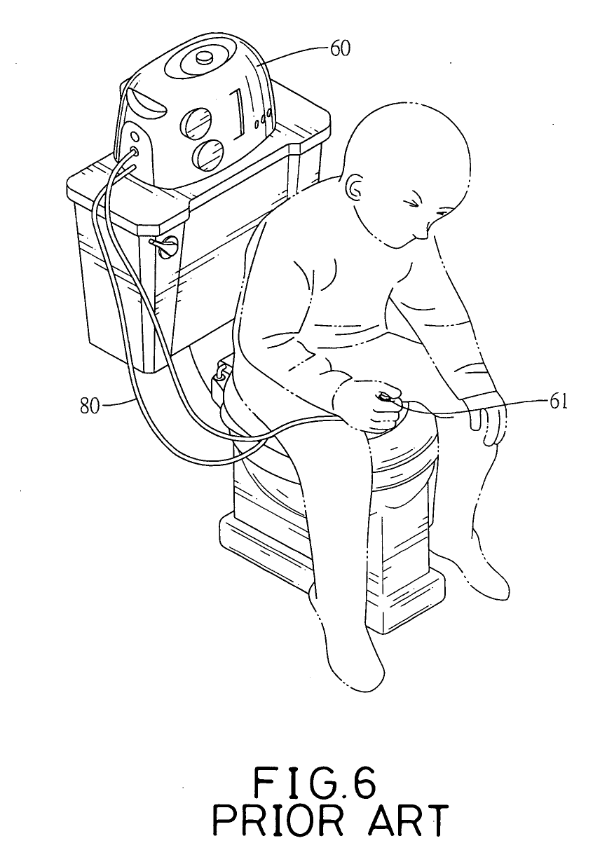

### DETAILED DESCRIPTION OF THE PREFERRED EMBODIMENT

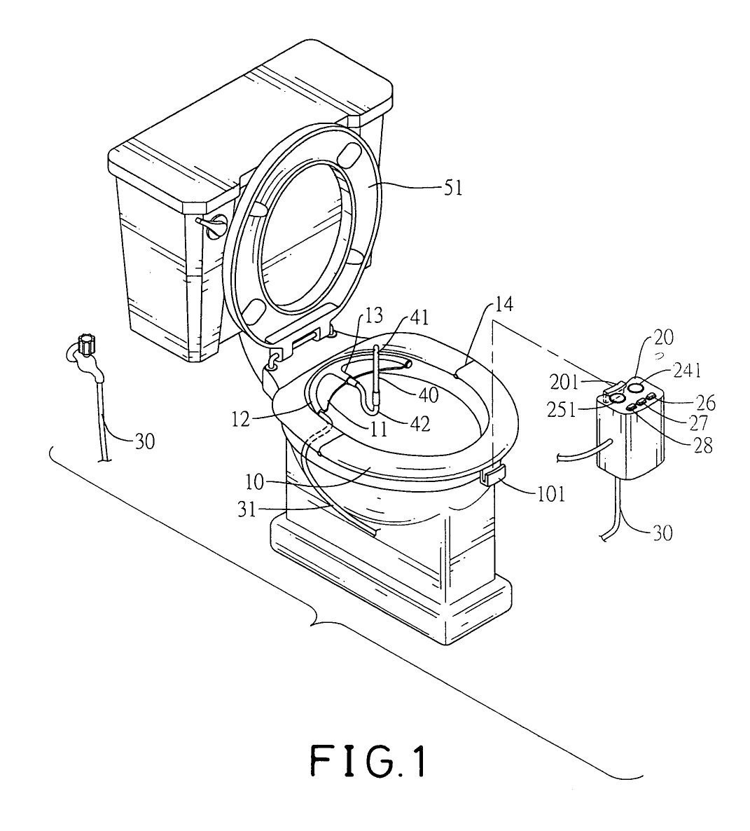

With reference to FIG. 1, a portable water therapy apparatus for the large intestine is provided on a toilet (not numbered) with a toilet bowl (not numbered). The water therapy apparatus has a positioning pad (10) with a front end, a rear end and two sides. A reinforced rib (11) is provided at the rear end of the positioning pad (10). An upward-facing hook (101) is formed on the front end of the positioning pad (10) and a controller (20) is mounted on the hook (101). The water therapy apparatus for the large intestine also has an inlet tube (30) and an outlet tube (31).

The toilet has a seat (51). The positioning pad (10) has a shape similar to the seat (51). The positioning pad (10) is placed on the toilet bowl. The positioning pad (10) has a pivotal portion (14) formed at a middle of each side, whereby the positioning pad (10) can be folded. The reinforced rib (11) has a guide tube (12) mounted thereon, and a pipe (13) extending from a middle of the guide tube (12). A nozzle (40) has a top end with multiple apertures (41) defined thereon. A lower end of the nozzle (40) forms a trap (42), which is connected to the pipe (13) and allows the direction of the nozzle (40) to be adjusted, so that the user will not be uncomfortable when inserting the nozzle (40).

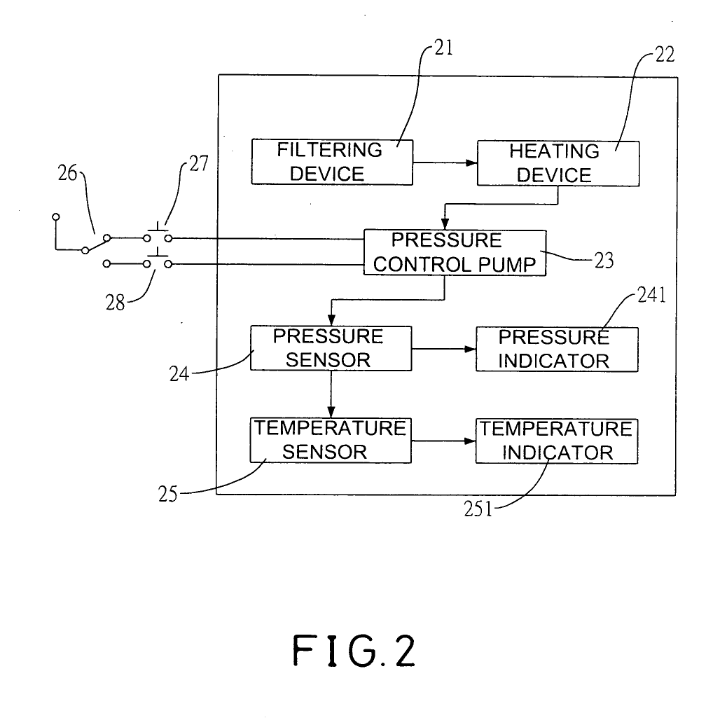

The controller (20) can be of any shape, in this embodiment, the controller (20) is cube shaped. With reference to FIG. 2, the controller (20) has a filtering device (21), a heating device (22), a pressure control pump (23), a pressure sensor (24), a temperature sensor (25), a pressure indicator (241), and a temperature indicator (251). The pressure control pump further connects with a switch system, which comprises a selector switch (26), a pressure switch (27) and a toggle switch (28). The pressure switch (27) allows for intermittent operation of the water therapy apparatus. When the pressure switch (27) is pressed and held, the controller (20) is activated and the apparatus starts to operate. Alternatively, when the pressure switch (27) is released, the controller (20) is deactivated and the apparatus stops at once. The toggle switch (28) allows for continuous operation. When the toggle switch (28) is pressed once the controller (20) is activated and the apparatus starts and continues to operate. When the toggle switch (28) is pressed a second time the controller (20) is deactivated and the apparatus stops operating. The selector switch (26) allows a user to choose between intermittent or continuous operation of the water therapy apparatus.

The pressure sensor (24) is connected to the pressure control pump (23) to detect the water pressure, and the pressure indicator (241) is connected to the pressure sensor (24) to show off the detected pressure. The temperature sensor (25) is connected to the pressure sensor (24) to detect the water temperature, and the temperature indicator (251) is connected to the temperature sensor (25) to show off the detected water temperature.

In addition, a downward-facing hook (201) is formed on the controller (20), which corresponds to the upward-facing hook (101) on the positioning pad (10) to mount the controller (20) on the positioning pad (10). When a user sits on the toilet, the controller (20) is positioned between the legs of the user.

The inlet tube (30) has two ends, a first end is connected to the pressure control pump (23) of the controller (20), and a second end is connected to a faucet. The filtering device (21) and the heating device (22) are connected to the inlet tube (30).

The outlet tube (31) has two ends, a first end is connected to the pressure control pump (23), and a second end is connected to the guide tube (12). The pressure sensor (24) and the temperature sensor (25) are connected to the outlet tube (31).

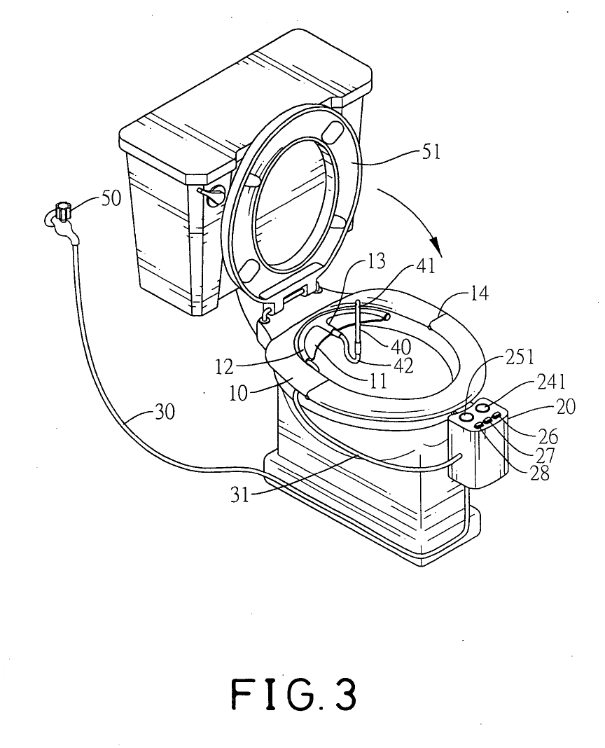

With reference to FIG. 3, the inlet tube (30) is connected to a faucet (50). When the controller (20) is activated, the pressure control pump (23) allows water from the faucet (50) to enter the inlet pipe (30). The water is cleaned in the filtering device (21) and heated in the heating device (22). The warmed water, the pressure regulated by the pressure pump (23), is then pumped through the guide tube (12) and flows to the nozzle (40) through the pipe (13), to finally spurt from the multiple apertures (41) in the nozzle (40) to the large intestine.

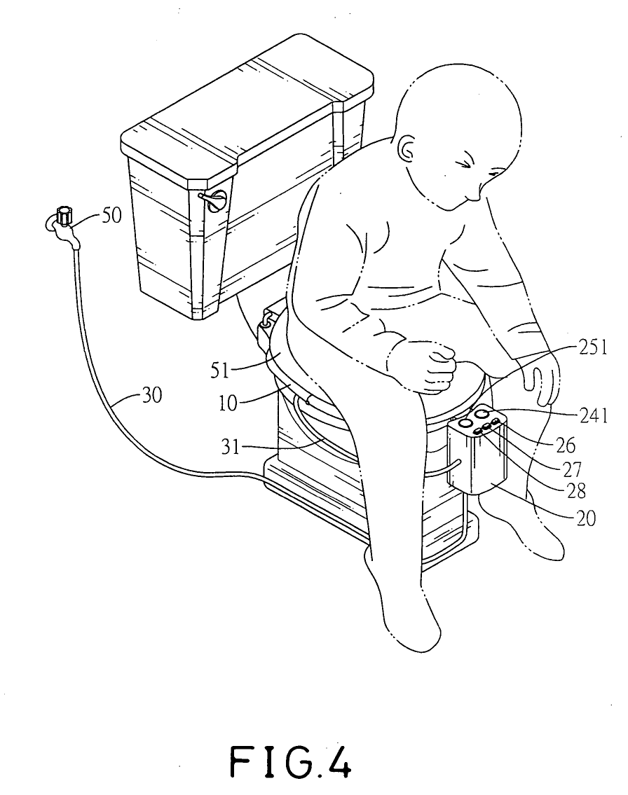

With reference to FIG. 4, when a user is to be treated by the water therapy apparatus, the seat (51) is laid down. With the help of the seat (51), the positioning pad (10) is held in place. The user sits on the seat (51) to allow the nozzle (40) to insert into the rectum through the anus. Sitting on the seat, the controller (20) is positioned between the legs of the user, which is convenient for the user to monitor the pressure indicator (241) and the temperature indicator (251). The user uses the selector switch (26) to choose either intermittent or continuous treatment. When the water treatment is done, the nozzle (40) is discarded and a new one is used the next time.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A portable water therapy apparatus for the large intestine comprising a positioning pad, a controller, an inlet tube, an outlet tube and a nozzle, wherein
the positioning pad has a guide tube;
the controller detachably mounted on the positioning pad and comprises a pressure control pump, a heating device connected to the pressure control pump, a filtering device connected to the heating device and a switch system connected to the pressure control pump;
the inlet tube has two ends, a first end is connected to the pressure control pump of the controller, and a second end is adapted to be connected to a faucet; and
the outlet tube has two ends, a first end is connected to the pressure control pump, and a second end is connected to the guide tube.

2. The portable water therapy apparatus for the large intestine as claimed in claim 1, wherein the positioning pad has two sides, and a pivotal portion is formed at a middle of each side.

3. The portable water therapy apparatus for the large intestine as claimed in claim 1, wherein the controller further comprises a pressure sensor connected to the pressure control pump, a temperature sensor connected to the pressure sensor, a pressure indicator connected to the pressure sensor, and a temperature indicator connected to the temperature sensor, with the pressure sensor and the temperature sensor connected to the outlet tube.

4. The portable water therapy apparatus for the large intestine as claimed in claim 3, wherein the switch system further comprises a selector switch, a in claim 3, wherein the switch system further comprises a selector switch, a pressure switch and a toggle switch, with the pressure switch and the toggle switch connected to the pressure control pump and the selector switch simultaneously connected to the pressure switch and the toggle switch.

5. The portable water therapy apparatus for the large intestine as claimed in claim 1, wherein a pipe extends from a middle of the guide tube and is connected with the nozzle, and the nozzle has a top end with multiple apertures defined thereon.

6. The portable water therapy apparatus for the large intestine as claimed in claim 1, wherein a lower end of the nozzle forms a trap to allow directional adjustment of the nozzle.
